(19) United States
(12) Patent Application Publication
(10) Pub. No.: US 2006/0085216 A1
(43) Pub. Date: Apr. 20, 2006

(54) Method and apparatus for discouraging non-meritorious lawsuits and providing recourse for victims thereof

(76) Inventor: John M. Guerrero, Palm City, FL (US)

Correspondence Address: SACCO & ASSOCIATES, PA, P.O. BOX 30999, PALM BEACH GARDENS, FL, 33420-0999, US

(21) Appl. No.: 11/248,747

(22) Filed: Oct. 12, 2005

Related U.S. Application Data
(60) Provisional application No. 60/619,511, filed on Oct. 15, 2004.

(51) Int. Cl. G06Q 99/00; H04L 9/00; H04K 1/00

(52) U.S. Cl. 705/1; 705/80

(57) ABSTRACT

A method for discouraging non-meritorious malpractice claims and providing recourse for victims thereof is provided. The method comprises collecting record data relating to medical malpractice litigation, selecting desired data from the record data using a case evaluation algorithm, and storing the desired data in a user accessible site database. The case evaluation algorithm selectively excludes predetermined information based on an outcome of a medical malpractice lawsuit. The selecting desired data step includes identifying a non-prevailing party and a non-prevailing attorney to a medical malpractice lawsuit. The site database includes a list of non-prevailing party and/or a list of non-prevailing attorney. A system for discouraging non-meritorious malpractice claims and providing recourse for victims thereof is also provided.

### CROSS REFERENCES TO RELATED APPLICATIONS

This application claims benefit of U.S. provisional patent application Ser. No. 60/619,511 filed on Oct. 15, 2004 which is herein incorporated by reference.

### BACKGROUND OF THE INVENTION

1. Statement of the Technical Field

The present invention relates to devices and techniques of discouraging non-meritorious, frivolous, and/or malicious lawsuits as well as methods for use thereof.

2. Description of the Related Art

Many industries in the United States are facing collapse due to the high prevalence of non-meritorious litigation and “jackpot justice.” Lured by promises of lump sum cash awards and “no-risk” contingency fee arrangements, Americans are suing in record numbers. In response, pharmaceutical industries are abandoning high-risk endeavors such as vaccine production and development of new drug classes in favor of low-risk options such as creating brand-name variations of existing drugs. Physicians are abandoning procedures and services that are associated with high risk of litigation including delivering babies, emergency/trauma care, and vascular surgery. Indeed, many physicians have an unwritten list of procedures they no longer perform or pathologies that they no longer treat solely because of liability concerns.

Attempts to correct this problem have largely been limited to the legislative arena. In the field of medical malpractice, the vast majority of these attempts have been in the form of proposed malpractice award “caps,” which have been unsuccessful in deterring frivolous lawsuits. As a result, less conventional means of discouraging frivolous medical malpractice lawsuits have emerged.

One method that emerged is the creation of an internet site (www.doctorsknow.us) to query a database which provides a list of known litigious patients, plaintiff attorneys, and expert witnesses. The database could be accessed only after the payment of a membership fee. Physicians are notoriously reluctant to spend money on intangible items and this frugality has been magnified by the skyrocketing overhead costs of running a medical practice. Even a nominal membership fee represents a phenomenal hurdle to widespread use by physicians. This “members only” approach created the appearance of an adversarial relationship between physicians and patients, when in fact quite the opposite should be true.

Although the internet site comprised a listing of patients who had filed lawsuits, little or no indication was provided as to how this information can be used by a physician-member in a legal and ethical manner. In addition to leaving the physician-member in an ethical limbo, the internet site left the public and the media fearing a worst case scenario as to how the information might be used.

The database made no significant attempts to differentiate plaintiffs who filed frivolous lawsuits from those who filed legitimate ones. True medical malpractice does occur, and victims of medical malpractice should not be punished for filing legitimate claims. Likewise, the database did not substantively discriminate between attorneys representing legitimate victims of malpractice and those who simply filed non-meritorious suits in the hope that the physician's insurance company would settle the frivolous claim rather than incur the risk and expense of a jury trial.

Also, no recourse was available to patients who found themselves on the database due to deception by their attorney. A patient who has experienced an undesirable medical outcome, for example, may be encouraged by an unscrupulous attorney to file a claim even though a reasonably prudent attorney would have found no cause for a medical malpractice suit. Such patients often find out at the end of a lengthy jury trial that no malpractice was committed. In addition to their initial injury, they have been misled by their attorney, they have gone through the stress and expense of a jury trial, they have lost the trial, and now, because of inappropriate counsel, they are listed on the database with no recourse whatsoever. In cases where the defendant made an offer of settlement, the plaintiff may even have been required to pay the defendant's attorney's fees and costs.

Another method that emerged is the creation an internet site to query a patient database which helps determine the statistical propensity of an individual to engage in litigious behavior against a physician. Much like the above described method, this site fosters a “doctors versus patients” mentality that is unsavory to physicians and patients alike. The patient database requires the payment of a subscription fee, a fact which automatically limits its use in the contemporary medical arena. The patient database depends on the collection of data from numerous sources beyond the legal record, including patient income, past medical history, past medical expenses, and more. Collecting this data can be cost prohibitive. Furthermore, much of the information this method proposes using in a statistical analysis is privileged information under the Health Insurance Portability and Accountability Act (HIPAA) and would be thoroughly inaccessible to anyone not directly involved in a patient's care. Finally, the ultimate output of the patient database is a “statistical probability” of litigious behavior. Ultimately, such a statistical probability will have little meaning to a physician who will likely be unfamiliar with the statistical techniques that were used to generate the result.

### SUMMARY OF THE INVENTION

The invention concerns a method for discouraging non-meritorious malpractice claims and providing recourse for victims. The method can include the steps of collecting record data relating to medical malpractice litigation, selecting desired data from the record data using a case evaluation algorithm, and storing the desired data in a user accessible site database. The case evaluation algorithm selectively excludes predetermined information based on an outcome of a medical malpractice lawsuit. For example, the case evaluation algorithm can select only those medical malpractice lawsuits in which a plaintiff is a non-prevailing party.

In general each named plaintiff in the medical malpractice lawsuit can be identified as a non-prevailing party where the lawsuit has been adjudicated against the plaintiff with respect to at least one named defendant in the medical malpractice lawsuit. Such adjudication can occur in several circumstances. For example, an adjudication can occur as a result of (1) a summary judgment, (2) a dismissal, (3) a withdrawal of the case by the plaintiff, or (4) a judgment in favor of a defendant. Once the case evaluation algorithm has selected only those cases where the plaintiff is properly identified as a non-prevailing party, a list of each non-prevailing party can be stored in the site database in the storing step.

According to one aspect of the invention, a non-prevailing attorney can also be identified for each malpractice lawsuit. A non-prevailing attorney is one who has represented a party to each medical malpractice lawsuit that has been identified from the record data as a non-prevailing party in the selecting step. A list of each non-prevailing attorneys can also be stored in the site database in the storing step.

According to another aspect of the invention, the process can include the step of generating a list of medical malpractice lawsuits from the stored data. For example, the list can be generated in response to a user query. The process can include generating a list in which an entity identified in a user query is a non-prevailing party or a non-prevailing attorney. This list can also be displayed in response to the user query.

According to another aspect of the invention, the process can also include storing in the accessible site database information identifying each medical malpractice lawsuit in which the non-prevailing party and/or non-prevailing attorney have been ordered by a court to pay a prevailing party's attorneys fees or litigation costs. Additional information can also be stored in the accessible site database based once the case evaluation algorithm has been applied. For example, the additional information can include for each medical malpractice lawsuit, the (1) state where the action was filed, (2) county where the action was filed, and (3) disposition of the medical malpractice lawsuit is identified in the site database (e.g. summary judgment, dismissal, a withdrawal of the case by the plaintiff, or judgment in favor of a defendant).

Attorney referral information can also be stored in the accessible sited database. Attorney referral information is not generally available in public records, but can be entered into the database by a party to the lawsuit or anyone else with knowledge of such information. The attorney referral information can be associated with a particular medical malpractice lawsuit contained in the database. Thereafter, information concerning referring attorneys can also be provided in response to a user inquiry. For example, user's can query the database with an individual attorney's name to determine if the particular attorney has a history of referring cases to other attorneys where the plaintiffs are ultimately non-prevailing parties to lawsuits.

The process can also include the step of providing various types of information to users. For example, such information can include an explanation of the case evaluation algorithm in response to a user inquiry, attorney referral information, or other types of information useful to health care providers, attorneys, and medical malpractice plaintiffs.

The invention can also include a system for discouraging non-meritorious malpractice claims and providing recourse for victims thereof. For example, the system can include a computer processor and a data store. The computer processor can be programmed for selecting desired data from at least one public record using a case evaluation algorithm. The case evaluation algorithm can automatically selectively exclude predetermined information based on an outcome of a medical malpractice lawsuit. The data store can be responsive to the computer processor for storing the desired data in at least one site database. The case evaluation algorithm can selectively exclude all malpractice lawsuits from the site database except for those where the plaintiff is properly identified as a non-prevailing party.

In general, the system can be designed for implementing the process as described above, including the case evaluation algorithm. The system can also receive and respond to user queries as described above with respect to the method of the invention described herein.

### BRIEF DESCRIPTION OF THE DRAWINGS

Embodiments will be described with reference to the following drawing figures, in which like numerals represent like items throughout the figures, and in which:

FIG. 1 is a flow diagram of an embodiment of a process for a database posting of data relating to medical malpractice litigation;

FIG. 2 is a block diagram of a data posting system for performing the database posting process illustrated in FIG. 1;

FIG. 3 is a flow diagram of an embodiment of a case evaluation algorithm used in the process of FIG. 1;

FIG. 4 is a block diagram of an informational computer system in accordance with an embodiment;

FIG. 5 is a flow diagram of a site use process performed by a user;

FIG. 6 is a schematic reference of a user computer system screen shot associated with use of Internet site, shown in FIG. 4; and

FIG. 7 is a schematic reference of a user computer system screen shots associated with use of Internet site, shown in FIG. 4.

### DETAILED DESCRIPTION OF THE PREFERRED EMBODIMENTS

To facilitate an understanding of the Detailed Description, definitions are provided for certain terms used therein. A “user” may be a person or an entity that uses or incorporates public record malpractice litigation information for its own purposes, such as a malpractice insurance provider, victims of medical malpractice, ethical attorneys seeking to help such victims, plaintiffs who have been coerced into non-meritorious medical malpractice actions by unethical attorneys, nurse practitioners, hospitals, physicians, and any member of the public.

An “application-programming interface” (API) is an interface between one program on the one hand and another program, an operating system, hardware and/or other functionality on the other hand. An API may allow for the creation of drivers and/or programs across a variety of platforms, where those drivers and programs interface with the API rather than (or in addition to) directly with the platform's operating system or hardware.

A “computer system” may include one computer or a network of individual computers (e.g., laptops, desktops, workstations, etc.) with appropriate operating systems and application programs, or it may be any combination of computing mechanisms or portions thereof and program instructions or modules.

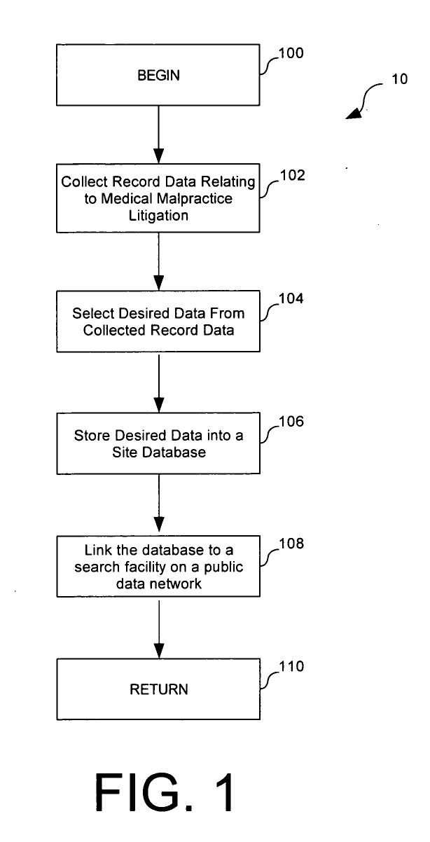

FIG. 1 is a flow diagram of an embodiment of a process for a database posting of data relating to medical malpractice litigation. Database posting process 10 comprises posting public record information about a medical malpractice lawsuit based on the outcome of a case. The database posting process 10 begins at step 100 and continues with step 102. In step 102, record data relating to medical malpractice litigation is collected from a source, such as a public record database. After record data is collected from a given public record, process 10 continues with step 104. In step 104, desired data is selected from the record data collected in step 102 through use of a case evaluation algorithm that selectively excludes predetermined information based on an outcome of a medical malpractice lawsuit. The case evaluation algorithm will be described in greater detail below. After desired data is selected, the process continues with step 106. In step 106, the desired data is stored in a site database. After storing desired data in a site database, site database is linked to a search facility on a public data network, as shown in step 108. After linking the site database to a public data network, step 110 is performed where process 10 returns to step 100.

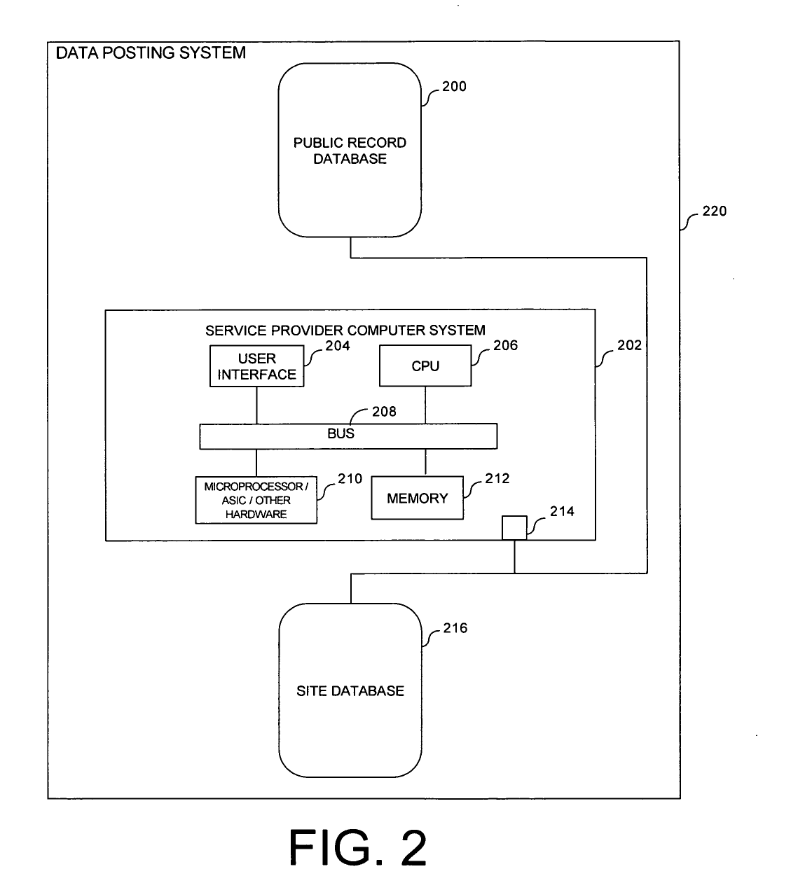

FIG. 2 is a block diagram of a data posting system for performing database posting process illustrated in FIG. 1. Data posting system 220 comprises a public record database 200, a service provider computer system 202, and a site database 216. Both public record database 200 and site database 216 may be coupled to service provider computer system 202 via a public data network, such as the Internet, or on a dial-up bulletin board system.

In the illustrated embodiment, service provider computer system 202 is comprised of a system interface 214, a user interface 204, a central processing unit 206, a system bus 208, a memory 212 connected to and accessible by other portions of service provider computer system 202 through system bus 208, and hardware entities 210 connected to system bus 208. At least some of the hardware entities 210 perform actions involving access to and use of memory 212, which may be a RAM, a disk driver, and/or a CD-ROM. Hardware entities 210 may include microprocessors, ASICs, and other hardware. Hardware entities 210 may include a microprocessor programmed for selecting desired data from a public record using a case evaluation algorithm that automatically selectively excludes predetermined information based on an outcome of a medical malpractice lawsuit. The case evaluation algorithm will be described in detail below. Hardware entities 210 may further comprise a data store responsive to the microprocessor for storing the desired data into site database 216 according to a given population scheme, such as lists of non-prevailing parties and lists of non-prevailing attorneys.

Since many counties may not have a public records database 200, those skilled in the art will appreciate that the record data from a public record can be mined by hand or automatically collected from a public records database 200 as described above. If the record data is mined by hand, the case evaluation algorithm, which will be described in more detail below, can be performed by the person doing data entry rather then by hardware entities 210. For example, prior to entering record data regarding a medical malpractice lawsuit, the person reviews the medical malpractice record for the outcome of the lawsuit. If the plaintiff prevailed, the person would not enter the medical malpractice lawsuits record data into the service provider computer system 202.

System interface 214 receives and communicates inputs from service provider computer system 202 to public record database 200 and site database 216. Therefore, inputs from an API from service provider computer system 202 are communicated from system interface 214 to public record database 200 and site database 216.

User interface 204 facilitates a user action to create a request to access litigation information stored in public record database 200, to collect record data relating to medical malpractice litigation from public record database 200, to select desired data from record data using a case evaluation algorithm, described in detail below, and to transmit desired data to site database 216 for storage. User interface 204 may comprise a computer display screen with an input means, such as a keyboard, directional pad, and/or a mouse.

Those skilled in the art will appreciate that the system architecture illustrated in FIG. 2 is one possible example of a computer system in which the process shown in FIG. 1 can be implemented. However, the invention is not limited in this regard and any other suitable computer system architecture can also be used without limitation.

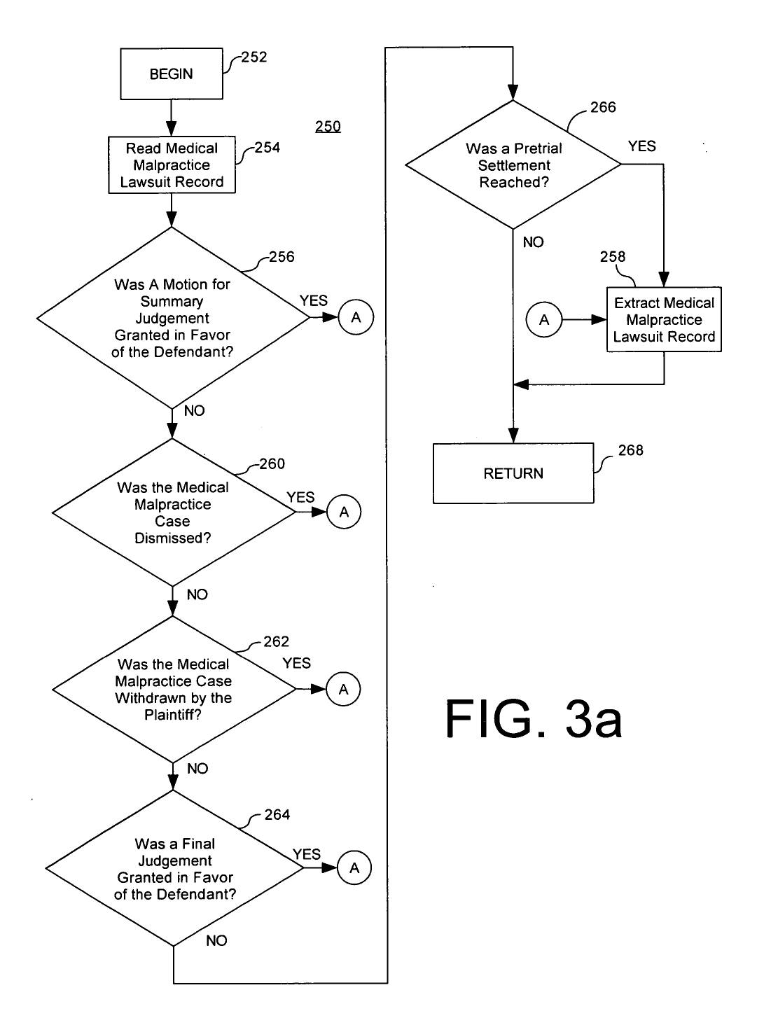

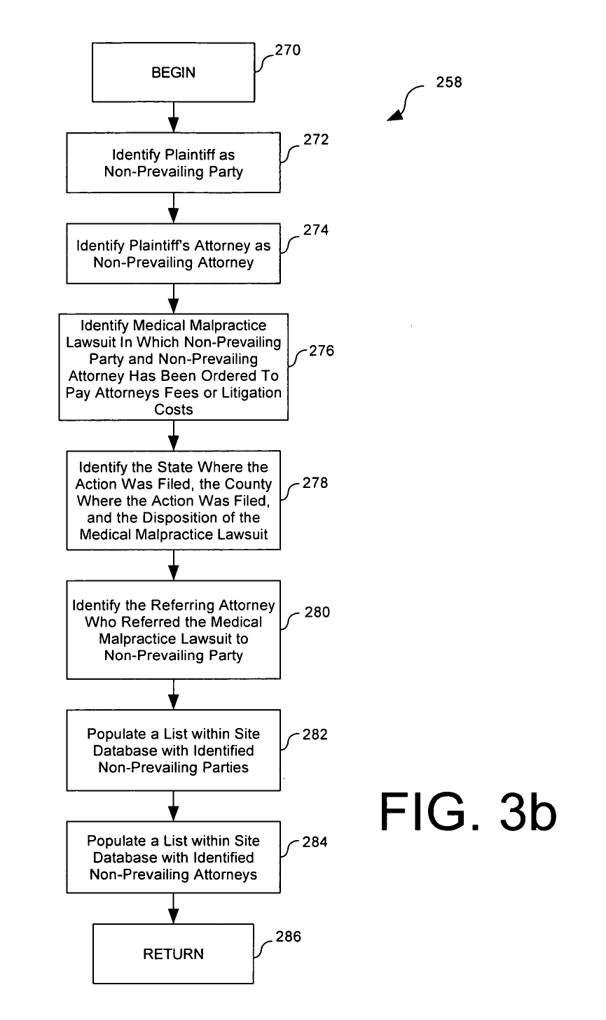

FIG. 3a is a flow diagram of an embodiment of a case evaluation algorithm used in the process for a database posting of data relating to medical malpractice litigation of FIG. 1. According to an embodiment, the case evaluation process 250 begins at step 252 and continues with step 254. In step 254, a medical malpractice lawsuit record is read. The medical malpractice lawsuit record can be any public record which sets forth the outcome of judicial proceedings. However, it can be advantageous for the medical malpractice lawsuit to contain a sufficient amount of detail to permit identification of non-prevailing plaintiffs and their attorneys as discussed below. Ideally, the medical malpractice lawsuit record can be in a machine readable form. However, in those instances where such records are not available, the data can be manually entered.

Upon reading the medical malpractice lawsuit record, case evaluation process 250 continues with step 256. In general, it should be noted that steps 256, 260, 262, 264 and 266 are process steps that are used to identify medical malpractice lawsuits in which the plaintiff can be properly identified as a non-prevailing party as that term is used herein. In those instances where detailed information regarding the malpractice lawsuit is not available, one or more of these steps can be optionally omitted.

Step 256 is a decision step where a determination is made as to whether or not a motion for summary judgment was granted in favor of any named defendant identified in the lawsuit record. If a motion for summary judgment was granted in favor of any such defendant, then process 250 can continue with step 258. In step 258, the medical malpractice record can be extracted from the public record database 200. If a motion for summary judgment was not granted in favor of the defendant, process 250 continues with step 260.

Step 260 is a decision step where a determination is made as to whether or not the medical malpractice case was dismissed with respect to any named defendant. If the medical malpractice case was dismissed, then process 250 continues with step 258. In step 258, the medical malpractice record can be extracted from the public record database 200. If the medical malpractice case was not dismissed, then process 250 continues with step 262. Step 262 is a decision task where a determination is made as to whether or not the medical malpractice case was withdrawn by the plaintiff with respect to any named defendant. If the medical malpractice case was withdrawn by the plaintiff, then process 250 continues with step 258. In step 258, the medical malpractice record is extracted from the public record database 200. If the medical malpractice case was not withdrawn by the plaintiff, then process 250 continues with step 264.

Step 264 is a decision step where a determination is made as to whether or not a final judgment was granted in favor of any named defendant in the medical malpractice lawsuit. If a final judgment was granted in favor of the defendant, the medical malpractice lawsuit is extracted from the public record database 200 in step 258. If a final judgment was not granted in favor of the defendant, then process 250 continues with step 266. Step 266 is a decision step where a determination is made as to whether or not a pretrial settlement was reached as between the plaintiff and any named defendant in the medical malpractice lawsuit. If a pretrial settlement was reached then the medical malpractice lawsuit is extracted from the public record database 200 in step 258. If a pretrial settlement was not reached, then the information in the medical malpractice lawsuit is excluded from the site database and the process 250 continues with step 268. In step 268, process 250 returns to step 252.

FIG. 3b is a flow diagram that shows a sub-process that includes a series of steps that together comprise step 258 shown in FIG. 3a. According to an embodiment, step 258 begins at step 270 and continues with step 272. In step 272, the plaintiff to the medical malpractice lawsuit can be identified as a non-prevailing party. After identifying the non-prevailing party, the process continues with step 274. In step 274, the plaintiff's attorney can be identified as a non-prevailing attorney. After identifying the non-prevailing attorney, the process can continue to step 276. In step 276, the medical malpractice lawsuit in which the non-prevailing party and the non-prevailing attorney has been ordered to pay attorneys fees or litigation costs can be identified. Thereafter, in step 278, the state where the action was filed, the county where the action was filed, and the disposition of the medical malpractice lawsuit can be identified. In step 280, the referring attorney who referred the medical malpractice lawsuit to the non-prevailing party can be optionally identified if this information has been provided. Alternatively, this information can be added at a later data. After the referring attorney, if any, is identified, the process continues with step 282.

The information identified in steps 272-284 can be used to populate a site database. For example, in step 282, a list within site database 216 can be populated with the identified non-prevailing party. Further, in step 284, a list within site database 216 can be populated with the identified non-prevailing attorney. The remaining information identified above in steps 272-282 can be optionally included in the database as well. Such information can be advantageously cross-referenced to the associated non-prevailing party and non-prevailing attorney. After the list is populated with the information as described herein, the process can continue on to step 286. In step 286, the sub-process associated with step 258 is completed with respect to the particular medical malpractice lawsuit record, and the process continues as described in FIG. 3a.

The case evaluation algorithm provides preeminent fairness to patient, physician and attorney. For example, in cases where a pretrial settlement is reached, the algorithm selectively includes both the plaintiff attorney(s) name and the plaintiff(s) name as desired data to be transmitted to site database 216 for posting. Likewise, the Case Evaluation Algorithm selectively excludes a plaintiff(s) and a plaintiff attorney(s) involved in a medical malpractice lawsuit in which a jury trial rendered a judgment in favor of the plaintiff. As a result, patients with legitimate claims of medical malpractice will not be inappropriately deterred from filing a claim against a negligent physician. Likewise, personal injury attorneys will have no fear of representing a legitimate victim of medical malpractice.

### EXAMPLE 1

In the event that a plaintiff named several defendants in an action, the plaintiffs name may be posted on site database 216 separately for each defendant against whom they did not prevail by jury verdict. For example while having surgery, Mr. Jones suffers an injury due to the negligence of Dr. Smith. Mr. Jones sues 6 (six) entities: Dr. Smith, Charity Hospital, Dr. Brown, Dr. Doe, Dr. Howard, and Dr. Fine. Mr. Jones later drops the case against Dr. Brown. A judge dismisses the case against Dr.'s Doe, Howard, and Fine. Charity Hospital settles with Mr. Jones out of court. A jury trial renders a verdict in favor of Mr. Jones in his action against Dr. Smith. In this example, Mr. Jones' name would appear on site database 216 five separate times (once for each defendant against which he did not receive a jury verdict in his favor). Mr. Jones' name would not appear on the web site for the case against Dr. Smith as Mr. Jones received a jury verdict in his favor in this case. This arrangement discourages plaintiffs and plaintiff attorneys from taking a “shotgun” or “barn door” approach to litigation. Plaintiffs and their counsel will be motivated to take the time to carefully analyze the facts and name in a lawsuit only those parties that showed clear evidence of negligence.

### EXAMPLE 2

Mrs. Franklin suffers an injury during surgery due to wrong-site surgery performed by her surgeon Dr. Hack. Mrs. Franklin checks the described database and finds that the attorney she was considering is listed dozens of times. Accordingly, she chooses another attorney, Mr. True. The attorney evaluates her case, counsels her as to her rights and options, and, with her written consent, files a medical malpractice lawsuit against Dr. Hack. The attorney recognizes that although other physicians participated in Mrs. Franklin's care, they were not party to the malpractice. For this reason, he does not name any other defendants in the lawsuit. Mr. True represents his client through a jury trial and wins a jury verdict against Dr. Hack. Applying the above described algorithm to this case, the plaintiff is listed in site database 216 for each defendant that she sued but against which she did not receive a jury verdict. In this case there was no such defendant; hence Mrs. Franklin is not listed on site database 216. Likewise, Mrs. Franklin's personal injury attorney, Mr. True, is listed in site database 216 for each defendant against which he filed suit but against which he did not receive a jury verdict. Again, in this case there was no such defendant; hence Mr. True is not listed on site database 216 as he filed a legitimate case. Appropriately, Dr. Hack's name is listed on National Practitioner Data Bank and the state department of insurance database.

### EXAMPLE 3

Mrs. Simpson claims she was injured by the medical negligence of her physician Dr. Doe. She retains an attorney, Mr. Burns, and files a medical malpractice claim against Dr. Doe. Prior to trial, an out-of-court settlement is reached. In this instance, the presence or absence of medical malpractice was never determined by jury trial. Regardless of whether or not Dr. Doe was at fault, his name is entered into the National Practitioner Data Bank and any relevant state databases. In the same way, Mrs. Simpson's claims of negligence (as presented by her attorney Mr. Burns) were never substantiated by adjudication. In fairness, Mrs. Simpson and Mr. Burns are treated the same way as the physician. The algorithm adds their names to the relevant sections of site database 216.

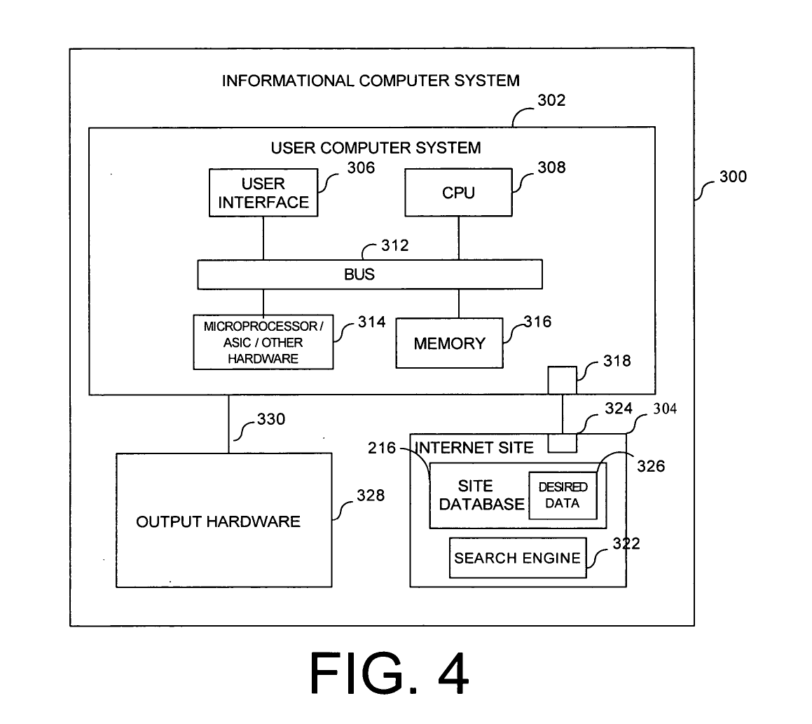

FIG. 4 is a block diagram of an informational computer system 300 in accordance with an embodiment of the invention. The informational computer system 300 comprises a user computer system 302, and an Internet site 304, and output hardware 328. The informational computer system 300 may contain a plurality of user computer systems 302 and Internet sites 304, and the connections to any of these systems need not be permanent. However, for ease of description, it will be assumed that the informational computer system 300 has one user computer system 302 and one Internet site 304. Communication between the user computer system 302 and the Internet site 304 can occur via a computer network through system interface 318 and system interface 324.

In the illustrated embodiment, the user computer system can be comprised of a system interface 318, a user interface 306, a central processing unit 308, a system bus 312, a memory 316 connected to and accessible by other portions of the user computer system 302 through system bus 312, and hardware entities 314 connected to the system bus 312. At least some of the hardware entities 314 perform actions involving access to and use of memory 316, which may be a RAM, a disk driver, and/or a CD-ROM. Hardware entities 314 may include microprocessors, ASICs, and other hardware. Hardware entities 314 may include a microprocessor programmed for accessing a computer network, such as the internet. System interface 318 receives and communicates inputs from user computer system 302 to Internet site 304. Therefore, inputs from the API from user computer system 302 are communicated from system interface 318 to Internet site 304.

User interface 306 facilitates a user action to create a request to access desired data 326 stored in site database 216, to print desired data 326, and/or to view desired data 326. User interface 306 may comprise a computer display screen with an input means, such as a keyboard and/or a mouse. Output hardware 328 is coupled to user computer system 302 by means of a suitable interface, such as output line 330. Output hardware 328 may be implemented using conventional devices, such as a disk drive, a printer, a display device, and/or other printing devices. Output hardware 328 allows storage of an output in memory 316 or a hard copy of an output to be produced.

Internet site 304 comprises a search engine 322 for querying site database 216. According to an embodiment, accessing Internet site 304 may not require the payment of a membership fee, so as not to discourage potential users from querying site database 216 and to make critical information available to patients who have been the victims of meritorious medical malpractice grievances. Advertisements may be present on the various web pages of Internet site 304, with revenue from the sale of advertising helping to defray the cost of operating Internet site 304.

Site database 216 may be available to a user via a public network such as the Internet, a private network, or on a dial-up bulletin board system. Therefore, site database 216 may be internal or external to Internet site 304. Where site database 216 is external, search engine 322 will query site database 216 via the Internet or a dial-up mechanism. Although only one database has been illustrated schematically in FIG. 4, a plurality of site databases may be provided. For example, a site database can be provided for non-prevailing attorneys and/or non-prevailing plaintiffs.

In accordance with an embodiment, site database 216 may contain information relevant to each of the various types of users of Internet site 304. Also, as described above, site database 216 may comprise desired data 326 selected from record data collected from a source such as plaintiff(s) name, name of plaintiff(s) attorney(s) of record, state and county in which the action was filed, disposition of case (for example, summary judgment, dismissal, case withdrawn by plaintiff, judgment in favor of defense, and/or other judicial outcomes), court orders to pay litigation costs or attorney's fees, and referring attorney. Desired data 326 may be stored on site database 216 in accordance with a given population scheme.

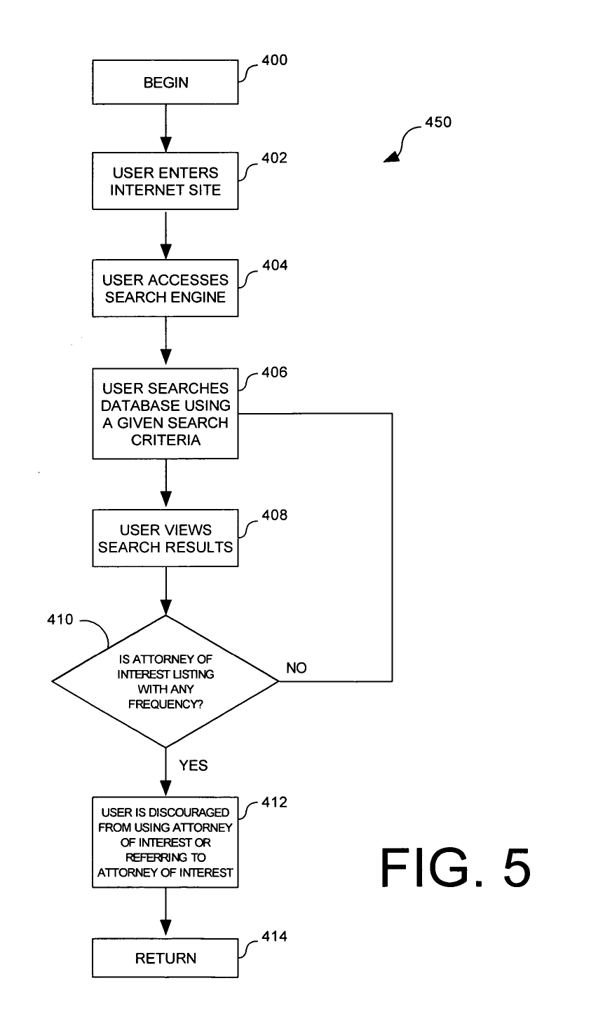

FIG. 5 is flow diagram of a site use process 450 performed by a user. Process 450 begins at step 400 and continues with step 402. In step 402, a user of the system will enter Internet site 304, shown in FIG. 3, via a connection to the Internet. Before entering Internet site 304, an entry page can appear which briefly describes the nature and content of Internet site 304.

According to an embodiment, a “plain English” legal disclaimer and users agreement can be presented on the entry page. Rather than having the user simply click “agree” or “disagree” to the disclaimer/users agreement, a series of multiple choice questions can be asked concerning relevant aspects of the user's agreement. User can be denied access to Internet site 304 until user demonstrates by correctly answering all the presented questions that user understands and accepts the user's agreement. The user's agreement can be subject to change as laws regarding contracts, computers, the internet and healthcare evolve. In general, the user's agreement can require the user to hold the web site's parent company, inventor, and agents harmless with regards to the contents of Internet site 304 or consequences of the use of any information on Internet site 304. The agreement can also allow access for personal use only, and never for the use of a third party or agency. Any third party/agency use can require completion of written contract(s) separate from the standard disclaimer and user's agreement. Further, in the event of litigation against the web site proprietor, the user can agree to compensate the company for its legal fees and costs if the user does not win a jury verdict. Also, should the user try to sue the company or its' agents, the user can be required to agree to use an attorney who maintains an appropriate legal malpractice policy.

After accepting the user's agreement, a “cookie” or similar device may be sent to user computer system 302 and stored in memory 316, shown in FIG. 4. The cookie (or similar device) may be required to use Internet site 304. This mechanism will prevent users from accessing Internet site 304 without understanding and accepting the user's agreement. By making the cookie time-limited, subsequent users of user computer system 302 will be denied access to Internet site 304 without also reading, understanding, and accepting the user's agreement.

After entering Internet site 304, process 450 will continue with step 404. In step 404, user will access search engine 322 which will query site database 216, as described above. To query site database 216, user can search using a given search criteria as indicated by step 406. As described above, the search criteria can include plaintiff(s) name, name of plaintiff(s) attorney(s) of record, state and county in which the action was filed, and disposition of case. After querying site database 216, a user can view the search results as indicated by step 408. Process 450 then continues with step 410, a decision step in which it is determined whether or not an attorney of interest is listed with any frequency. If an attorney of interest is not listed with any frequency, then process 450 returns to step 406. If an attorney of interest is not listed with any frequency, the user may choose to employ said attorney, or may continue process 450. Process 450 continues with step 412. In step 412, user may be discouraged from using said attorney of interest or from referring a colleague, client, and/or friend to said attorney of interest. Process 450 then continues with step 414 and returns to step 400.

An example of process 450 is as follows. A patient feels they may have been the victim of medical malpractice. The patient faces the task of finding an ethical and competent personal injury attorney. Such a patient will access Internet site 304 free of charge and determine whether the attorney they are considering appears with any frequency on site database 216. Attorneys who regularly pursue non-meritorious cases (or botch meritorious ones) are likely to appear frequently on site database 216. By checking site database 216 prior to selecting an attorney, the injured patient is better informed and therefore better able to avoid unethical or incompetent attorneys.

In a similar fashion, attorneys who do not handle personal injury cases may wish to refer a client with a malpractice claim to an attorney who does. By searching site database 216, a referring attorney can avoid sending their client to a lawyer with an extensive history of pursuing losing cases.

Likewise, a physician may access Internet site 304 free of charge and query site database 216 using a given patients name as the search criteria. After reviewing the medical malpractice record, the physician determines whether or not the patient who filed a non-prevailing case had unrealistic expectations. Upon making a determination, the physician can proceed with caution or can be obligated to defer a non-emergent case.

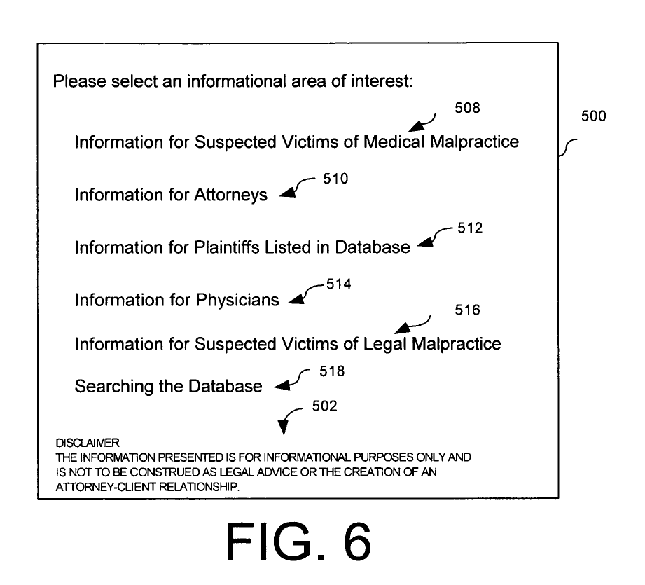

FIG. 6 is a schematic reference of user computer system 302 screen shot associated with use of Internet site 304 in accordance with site use process 450. In the illustrated embodiment, display 500 includes hypertext to allow a user to browse and select an informational area, such as Information for Suspected Victims of Medical Malpractice 508, Information for Attorneys 510, Information for Plaintiffs Listed in Database 512, Information for Physicians 514, Information for Suspected Victims of Legal Malpractice 516, and Searching the Database 518. In the illustrated embodiment, the user can highlight an informational area of interest 508, 510, 512, 514, 516, 518 and can clicks on the desired informational area to access a respective informational web page.

In accordance with an embodiment, Information for Suspected Victims of Medical Malpractice 508 web page can include a disclaimer, an introduction to medical malpractice including timelines of a medical malpractice suit, explanation of techniques used by trial lawyers to maximize profits, and an explanation of contingency fee arrangements, how to shop around for the best deal, pros and cons of using personal injury “brokers,” a menu to allow a user to search site database 216, and advertisements relating to legal representation by attorneys who maintain excellent success rates.

In accordance with an embodiment, Information for Attorneys 510 web page may include information to attorneys as to the operation of the above described case evaluation algorithm and Informational computer system 300, shown in FIG. 4. In addition, information on how to advertise with the site may be provided. In states where the collection of a finder's fee is permissible under the conditions present, attorneys will be provided with information on how to establish a referral arrangement with the web site, its parent company, or agents of its parent company as allowed by law.

In accordance with an embodiment, Information for Plaintiffs Listed in Database 512 web page may include information as to how a plaintiffs name came to be listed on Internet site 304. The information may be presented in a format similar to newspaper or magazine articles. Information for Plaintiffs Listed in Database 512 may provide a “Frequently Asked Questions” or “FAQ's” section including a set of given questions and corresponding answers.

In accordance with an embodiment, a “FAQ's” section may include the following questions “Why You are Listed On Our Database,” “Why You are Listed if You Settled Your Case,” “Why You May Be Listed if You “Won” Your Case,” “Having Your Case Reviewed for Evidence of Legal Malpractice,” “Reporting your attorney to the state bar,” “Disclosing a Personal Injury “Broker,”” “Having Your Case Reviewed For Evidence of Expert Witness Malpractice” along with corresponding answers.

The answer to “Why You are Listed On Our Database” may begin by educating a listed plaintiff of the legality of obtaining and displaying public record information. For example, the answer may include the following explanation. Prior to filing a lawsuit on a client's behalf, an ethical personal injury attorney will inform their client that the existence of the civil action, its nature, and its outcome will all become matters of public record. Most competent trial lawyers will have the client sign an informed consent to this effect prior to filing a lawsuit on the client's behalf. The answer may further comprise a reference to “Having Your Case Reviewed for Evidence of Legal Malpractice” and “Reporting your attorney to the state bar.”

The answer to “Why You are Listed if You Settled Your Case” may include the following explanation. When a physician settles a case out of court, his or her name is registered on the National Practitioner Data Bank (NPDB) and in some states (for example, Florida) on the web-accessible database for the state's Department of Insurance. Although the existence of malpractice was never established, the doctor's name is listed and the public is left to make the determination as to what to do with this information. In the interest of fairness and uniformity, this same principle is applied to plaintiffs who have settled their case rather than obtaining a jury verdict. The answer may further comprise an explanation addressing the events after a medical malpractice lawsuit is settled out of court. For example in such a case, the defendant's or physician's name is entered into the National Practitioners Database and into site database 216, shown in FIG. 4. The answer may comprise a reference to other questions and answers such as “Having Your Case Reviewed for Evidence of Legal Malpractice” and “Reporting your lawyer to the state bar.”

The answer to “Why You May Be Listed if You “Won” Your Case” may address concerns by a plaintiff who is listed with frequency despite being involved in a single medical malpractice lawsuit and received a jury verdict in his favor. For example, a plaintiffs attorney sued multiple non-negligent defendants in addition to a negligent defendant; the plaintiff may still be listed on the database for each defendant against which the plaintiff did not receive a jury verdict. The answer may further address a plaintiff who is unaware that he sued multiple physicians until viewing the information contained on site database 216. Such a plaintiff may be referred to “Having Your Case Reviewed for Evidence of Legal Malpractice” and “Reporting your attorney to the state bar.”

The answer to “Having Your Case Reviewed for Evidence of Legal Malpractice” may be preceded by a disclaimer stating “The information presented is for informational purposes only and is not to be construed as legal advice or the creation of an attorney-client relationship.” The answer may provide a definition of malpractice and the pros and cons of filing a malpractice lawsuit. The answer may include a list of attorneys, advertisements directing a user to a given attorney, and/or a menu or user prompt for providing attorney referral information.

The answer to “Reporting Your Attorney to the State Bar” may provide information regarding how a client can report their attorney to a given states bar association. The answer to “Disclosing a Personal Injury “Broker”” may include an explanation of joint legal representation and how an attorney, who is jointly representing a plaintiff, may not be accounted for on site database 216. A plaintiff listed on site database 216 may be given the option to provide documentation of joint representation so that all attorneys who worked on a case may be listed on site database 216. The answer may further include a reference to “Having Your Case Reviewed for Evidence of Legal Malpractice” and “Reporting your attorney to the state bar”.

The answer to “Having Your Case Reviewed For Evidence of Expert Witness Malpractice” may include an explanation of the role that expert witnesses play in medical malpractice lawsuits, how to have a case reviewed for evidence of expert witness malpractice, and how to report an expert witness to a respective medical licensing board and/or specialty societies in the event that the plaintiff was harmed by inaccurate, fraudulent, or misleading testimony on the part of the expert witness.

In accordance with an embodiment, Information for Physicians 514 may comprise advertisements and information regarding how to use the information on the database. For example, the information on Internet site 304 may not be used to refuse care in an emergency room setting, may be used to lower the threshold for referral to a sub-specialist or tertiary care center, may be used to reinforce the need for superlative detail in documentation of the patient's medical record, may be used to alert the physician to the need for expanded informed consent, may be used in an emergency room situation to determine whether or not to continue the care for a patient in a long-term outpatient setting, and may be used in a office-based/non-emergent care situation to determine whether or not to have future dealings with a listed patient or attorney. The web page may further comprise information regarding ERISA/EMTALA, a physician's responsibilities with regards to emergency room care, relevant legal precedent, and whether a doctor should refuse to provide non-emergent medical care to attorneys.

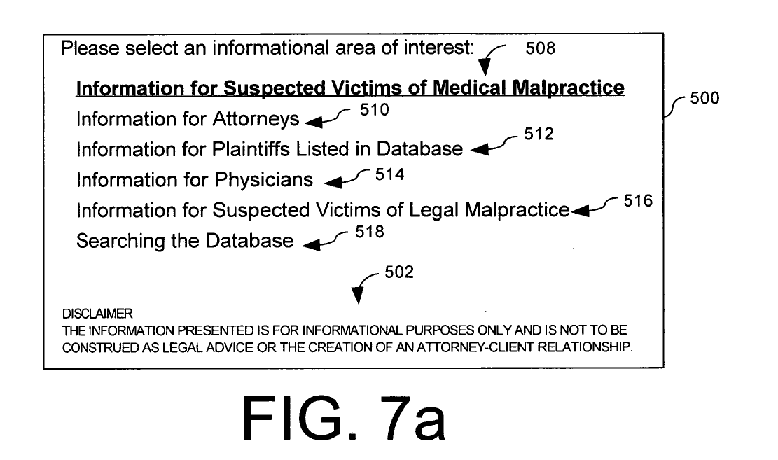

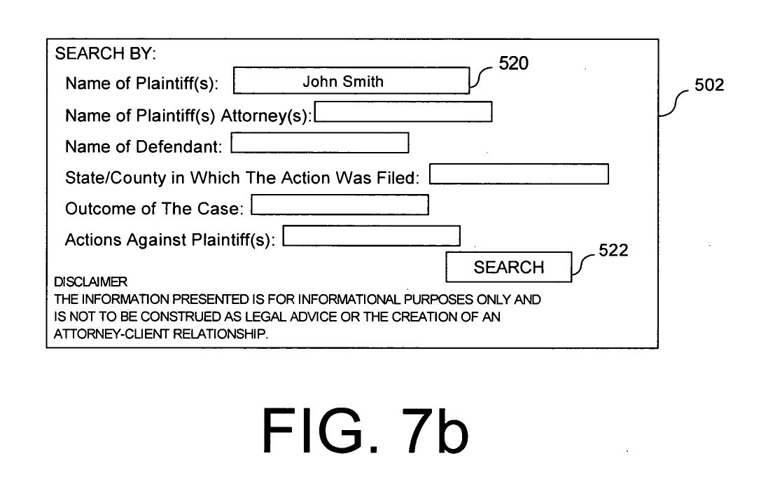

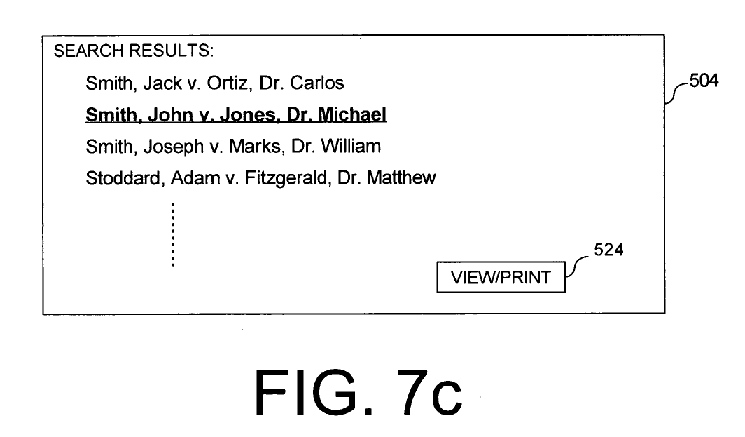

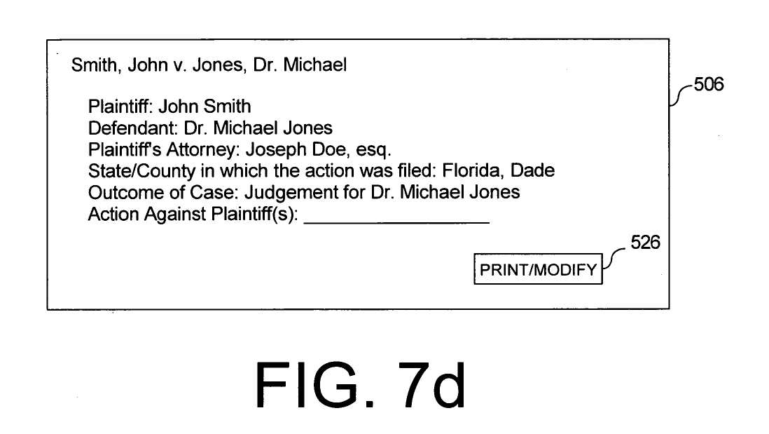

FIGS. 7a-7d are a series of user computer system screen shots associated with use of Internet site 304 in accordance with site use process 450. As shown in FIG. 7a, a user can select Information for Suspected Victims of Medical Malpractice 508. After highlighting and clicking on hypertext 508, display 502 appears on the computer screen as shown in FIG. 7b. Display 502 allows the user to query the site database 216, shown in FIG. 4, by given fields, such as name of plaintiff(s), name of attorney(s), name of defendant(s), state and/or county in which an action was filed, outcome of a case, and actions against a plaintiff(s). Display 502 may further comprise a disclaimer 516. After inputting search criteria into field space 520, the user clicks on search button 522.

After user enters search criteria into the user computer system 302, display 504 appears on the computer screen as shown in FIG. 7c. Display 504 comprises a list including search results of site database 216. The list generated may include medical malpractice lawsuits similar to the entity identified by a user query. Display 504 includes a menu 524 to allow user to view a desired record of the list and/or to print the list. If user chooses to view a record, display 506 will appear on the computer screen as shown in FIG. 7d. Display 506 comprises a detailed description of the desired record including names of the parties to a lawsuit, the state and county the suit was brought, the outcome of the case, and other information gathered from sources. Display 506 includes a menu 526 to allow user to print the detailed description and/or to modify the detailed description.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

I claim:

1. A method for discouraging non-meritorious malpractice claims and providing recourse for victims thereof, said method comprising:
collecting record data relating to medical malpractice litigation;
selecting desired data from the record data using a case evaluation algorithm that selectively excludes predetermined information based on an outcome of a medical malpractice lawsuit; and
storing said desired data in a user accessible site database.

2. The method according to claim 1, wherein said selecting step further comprises identifying each said medical malpractice lawsuit in which a plaintiff is a non-prevailing party.

3. The method according to claim 2, wherein said selecting step further comprises identifying as said non-prevailing party each named plaintiff in said medical malpractice lawsuit where the lawsuit has been adjudicated against the plaintiff with respect to at least one named defendant in said medical malpractice lawsuit as a result of an occurrence selected from the group consisting of (1) a summary judgment, (2) a dismissal, (3) a withdrawal of the case by the plaintiff, (4) a judgment in favor of a defendant, and (5) a pretrial settlement.

4. The method according to claim 3, wherein said storing step further comprises storing in said site database a list of each said non-prevailing party.

5. The method according to claim 3, wherein said selecting step further comprises identifying from said record data a non-prevailing attorney representing a party to each said medical malpractice lawsuit that is a non-prevailing party.

6. The method according to claim 5, wherein said storing step further comprises storing in said site database a list of each said non-prevailing attorneys.

7. The method according to claim 5, further comprising displaying a list of said medical malpractice lawsuits in which an entity identified in a user query is at least one of a non-prevailing party and a non-prevailing attorney.

8. The method according to claim 7, further comprising identifying in said site database each of said medical malpractice lawsuits in which at least one said non-prevailing party and said non-prevailing attorney has been ordered by a court to pay a prevailing party's attorneys fees or litigation costs.

9. The method according to claim 7, further comprising identifying in said site database additional information associated with each said malpractice lawsuit selected from the group consisting of (1) state where the action was filed, (2) county where the action was filed, and (3) disposition of the medical malpractice lawsuit.

10. The method according to claim 5, further comprising providing attorney referral information responsive to a user inquiry.

11. The method according to claim 5, further comprising providing an explanation of said case evaluation algorithm in response to a user inquiry.

12. The method according to claim 5, further comprising identifying a referring attorney who referred said medical malpractice lawsuit to said non-prevailing attorney.

13. A system for discouraging non-meritorious malpractice claims and providing recourse for victims thereof, said system comprising:
a computer processor programmed for selecting desired data from at least one public record using a case evaluation algorithm that automatically selectively excludes predetermined information based on an outcome of a medical malpractice lawsuit; and
a data store responsive to said computer processor for storing said desired data in at least one site database.

14. The system according to claim 13, wherein said case evaluation algorithm identifies each said medical malpractice lawsuit in which a plaintiff is a non-prevailing party.

15. The system according to claim 13, wherein said case evaluation algorithm identifies as said non-prevailing party each named plaintiff in said medical malpractice lawsuit where the lawsuit has been adjudicated against the plaintiff with respect to at least one named defendant in said medical malpractice lawsuit as a result of an occurrence selected from the group consisting of (1) a summary judgment, (2) a dismissal, (3) a withdrawal of the case by the plaintiff, (4) a judgment in favor if a defendant, and (5) pretrial settlement.

16. The system according to claim 15, wherein said computer processor stores in said at least one site database a list of each said non-prevailing party.

17. The system according to claim 15, wherein said case evaluation algorithm identifies from said at least one public record a non-prevailing attorney representing a party to each said medical malpractice lawsuit that is a non-prevailing party.

18. The system according to claim 17, wherein said computer processor stores in said at least one site database a list of each said non-prevailing attorney.

19. The system according to claim 17, wherein said computer processor generates a list of said medical malpractice lawsuits in which an entity identified in a user query is at least one of a non-prevailing party and a non-prevailing attorney.

20. The system according to claim 19, wherein said at least one site database includes information identifying said medical malpractice lawsuits in which at least one of said non-prevailing party and non-prevailing attorney has been ordered by a court to pay a prevailing party's attorneys fees or litigation costs.

21. The system according to claim 19, wherein said at least one site database includes for each said medical malpractice lawsuit additional information elected from the group consisting of (1) state where the action was filed, (2) county where the action was filed, and (3) disposition of the medical malpractice lawsuit.

22. The system according to claim 17, wherein said computer processor is responsive to a user inquiry for providing attorney referral information.

23. The system according to claim 17, wherein said computer processor is responsive to a user inquiry for providing information that includes an explanation of said case evaluation algorithm.

24. The system according to claim 5, wherein said computer processor is responsive to a user input for adding to said at least one site database an identity of a referring attorney who referred said medical malpractice lawsuit to said non-prevailing attorney.
